(19) United States
(12) Patent Application Publication
(10) Pub. No.: US 2006/0078844 A1
(43) Pub. Date: Apr. 13, 2006

(54) Oral care systems, oral care devices and methods of use

(76) Inventors: Paul D. Goldman, Marlborough, MA (US); Richard H. Cohen, Sherborn, MA (US); Long Sheng Yu, South Grafton, MA (US); Alexander T. Chenvainu, Sudbury, MA (US); Eric France, Quincy, MA (US)

Correspondence Address: FISH & RICHARDSON P.C., P.O. BOX 1022, MINNEAPOLIS, MN, 55440-1022, US

(21) Appl. No.: 10/960,467

(22) Filed: Oct. 7, 2004

(51) Int. Cl. A61C 17/02

(52) U.S. Cl. 433/80; 601/162

(57) ABSTRACT

Oral care devices are provided that are capable of ejecting an air-liquid combination. In some implementations, the oral care devices include an applicator including a passageway within the applicator for directing the air-liquid combination therethrough; a plurality of brushing elements extending from a base at a head of the applicator to free distal ends, the head being sized to fit in a user's mouth; and a flexible nozzle in communication with the passageway and extending outwardly beyond the base at the head, the flexible nozzle configured to direct liquid droplets of the air-liquid combination beyond free distal ends of the brushing elements during brushing.

### TECHNICAL FIELD

This invention relates to oral care systems, and more particularly to oral care systems capable of delivering an air-liquid combination.

### BACKGROUND

Conventional toothbrushes, having tufts of bristles mounted on a head, are generally effective at removing plaque from the flat surfaces of teeth and the areas between teeth and along the gumline that can be accessed by the bristles. Typically, a consumer manually squeezes a globule of paste from a tube onto the bristles of the conventional brush prior to placing the brush in their mouth. After paste is deposited on the bristles, the brush is placed in their mouth and brushing commences.

Other oral care devices have been proposed directed to preventing periodontal disease. For example, U.S. Pat. No. 5,820,373 describes a periodontal cleaning device in the form of a coaxial nozzle that can jet-out quantities of compressed air and a liquid agent using a siphon effect.

### SUMMARY

Aspects of the invention feature an oral care device capable of producing an air-liquid combination that can be delivered to the teeth, for example, during brushing.

In one aspect, the invention features an oral care device capable of ejecting an air-liquid combination, including (a) an applicator including a passageway within the applicator for directing the air-liquid combination therethrough; (b) a plurality of brushing elements extending from a base at a head of the applicator to free distal ends, the head being sized to fit in a user's mouth; and (c) a nozzle, in communication with the passageway and extending outwardly from the base at the head, the nozzle having an elastomeric portion and being configured to direct liquid droplets of the air-liquid combination beyond free distal ends of the brushing elements during brushing.

In another aspect, the invention features an oral care system for home use by a consumer, the oral care system including (a) a compressor for generating pressurized air; (b) a liquid supply configured to allow liquid to be introduced to the pressurized air to form an air-liquid combination; (c) an applicator including a passageway within the applicator extending to an outlet at a head of the applicator for ejecting the air-liquid combination, the head being sized to fit within the consumer's mouth; and (d) a plurality of brushing elements extending from a base at the head of the applicator. In this aspect, the compressor compresses the pressurized air within the passageway to between about five and about 25 pounds per square inch.

In a further aspect, the invention features an oral care device capable of ejecting an air-liquid combination, including (a) an applicator including a passageway within the applicator for directing the air-liquid combination therethrough; (b) a plurality of brushing elements extending from a base at a head of the applicator, the head being sized to fit within a user's mouth; and (c) multiple nozzles extending from the base, at least one of the nozzles being in communication with the passageway for ejecting the air-liquid combination.

The invention also features an oral care system including (a) an applicator including a passageway within the applicator for directing a pressurized air therethrough; and (b) an obstructing member configured to interrupt the pressurized air within the passageway such that the air-liquid combination is ejected from the applicator as pulses.

In another aspect, the invention features an oral care device capable of ejecting an air-liquid combination, including an applicator including multiple passageways within the applicator, each of the multiple passageways arranged to direct a respective air-liquid combination to at least one outlet at a head of the applicator. The device may include first and second air-liquid combinations, wherein the first air-liquid combination comprises a first liquid, and the second air-liquid combination comprises a second liquid. For example, the first and second liquids may have different formulations, contain different actives, or have different rheologies.

The invention also features methods of oral care, for example including projecting liquid in the form of liquid droplets outwardly beyond free distal ends of brushing elements extending from a base at a head of an oral care device, while brushing with the brushing elements. The projecting step may occur while at least some of the brushing elements contact the user's teeth.

In a further aspect, the invention features an oral care device that includes (a) an applicator including a passageway within the applicator for directing the air-liquid combination therethrough, the applicator having a head portion sized to fit in a user's mouth; (b) within the applicator, a compressor for providing compressed air to the drive the air-liquid combination; and (c) a nozzle having an elastomeric portion, in communication with the passageway and extending outwardly beyond the base at the head, the nozzle being configured to direct liquid droplets of the air-liquid combination beyond free distal ends of the brushing elements during brushing.

In some implementations of the above aspects of the invention, the oral care device includes a linear diaphragm compressor. The linear compressor may include a shuttle configured to prevent non-axial movement of the diaphragm(s) of the compressor. The shuttle may be mounted on a crankshaft configured to drive movement of the shuttle which in turn deflects the diaphragms.

Some implementations of the invention can have one or more of the following advantages. In some cases, the air-liquid combination is delivered at a rate to open a user's gumline to provide access to the subgingival region. This can facilitate improved deliverability of oral treatments to the subgingival region and, in certain cases, can allow bristles (e.g., of a power toothbrush) to clean below the gumline. In some embodiments, the oral care device is capable of ejecting the air-liquid combination while operating at relatively low air pressures and liquid flow rates. Thus, the oral care device can be suitable for home use.

In certain cases, the oral care device is designed to provide relatively continuous delivery of the air-liquid combination or provide intermittent bursts of the liquid air combination throughout, for example, the entire brushing cycle. This can simplify oral care for a user by rendering unnecessary manual reapplication of treatments to bristle tips during the brushing cycle. Additionally, in some cases, the air-liquid combination can be formulated as a replacement for toothpaste, making manual application of toothpaste to the bristle tips unnecessary.

The details of one or more embodiments of the invention are set forth in the accompanying drawings and the description below. Other features and advantages of the invention will be apparent from the description and drawings, and from the claims.

### DESCRIPTION OF DRAWINGS

FIG. 1 is a perspective view of an oral care system including docking station and oral care device.

FIG. 2 is an exploded view of components of the docking station of FIG. 1.

FIG. 2A illustrates an embodiment of a pump assembly.

FIGS. 3A and 3B illustrate an embodiment of an oral care device in use.

FIG. 4 is a sectional view of a nozzle.

FIG. 5 is a perspective front view of a head of an oral care device.

FIG. 5A is a cross section of the head of FIG. 5.

FIGS. 6A and 6B are front and rear perspective views of a distal portion of an oral care device having a nozzle offset from an axis of rotation.

FIGS. 7A and 7B are front and rear perspective views of a distal portion of an oral care device having a movable head portion and a stationary head portion.

FIG. 8 is a perspective front view of a head for use with an oral care device.

FIG. 9 is a perspective front view of another embodiment of a head for use with an oral care device.

FIG. 10 is an exploded view of components of another embodiment of a docking station.

FIG. 11 is an exploded view of components of a third embodiment of a docking station.

FIG. 12 is an exploded view of components of yet another embodiment of a docking station.

FIG. 13 is an exploded view of components of another docking station embodiment.

FIGS. 14-18 illustrate various reservoir embodiments.

FIG. 19 is a side view of components of a self-contained oral care device that does not include a line connecting the device to a docking station.

FIGS. 20-23 are side views of components of various alternative self-contained oral care devices.

FIG. 24 is a schematic diagram for the self-contained oral care device shown in FIG. 19.

FIG. 25 is a schematic diagram for the self-contained oral care device shown in FIG. 21.

FIG. 26 is a circuit diagram showing a circuit that may be used in the oral care device of FIG. 1.

FIG. 27 is a perspective view of a dual diaphragm compressor suitable for use in the oral care devices described herein.

FIG. 27A is a cross-sectional view of the compressor, taken along line A-A in FIG. 27.

FIG. 28 is a partially exploded perspective view showing the components of the compressor of FIG. 27 (only one side of the dual diaphragm compressor assembly is exploded out; the other half remains in the compressor housing).

FIG. 28A is an enlarged exploded view of a subset of the components of the compressor.

FIG. 29 is a side view of components of a self-contained oral care device according to another embodiment.

### DETAILED DESCRIPTION

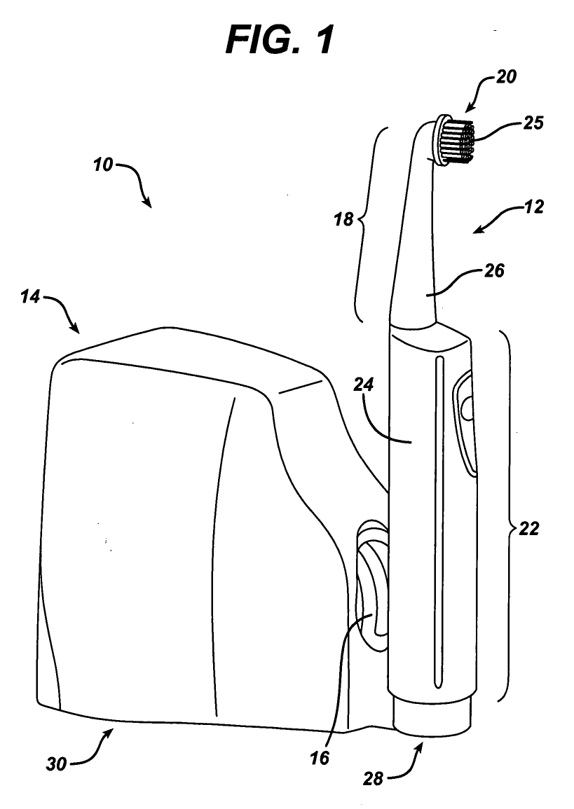

Referring to FIG. 1, an oral care system 10 includes an oral care device 12, in this case a power toothbrush, and a docking station 14. Docking station 14 is designed to generate an air-liquid combination that is directed along a fluid passageway and ejected (e.g., in the form of a spray) through an outlet 25 located in a head 20 of the oral care device 12. An exit line 16 (e.g., a coiled tube) connects the oral care device 12 to the docking station 14 and provides a portion of the fluid passageway along which the air-liquid combination travels from the docking station to the oral care device. As will be discussed in detail below, the docking station 14 is configured to supply air and liquid through line 16. The docking station may also supply power to the oral care device, either directly or by recharging rechargeable batteries contained in the device.

The oral care device 12 includes a distal portion 18 at which a movable head 20 is located and a proximal portion 22 at which a handle 24 is located. A neck 26 connects handle 24 and head 20. Head 20 is sized to fit within a user's mouth for brushing, while the handle 24 is graspable by a user and facilitates manipulation of the head 20 during use.

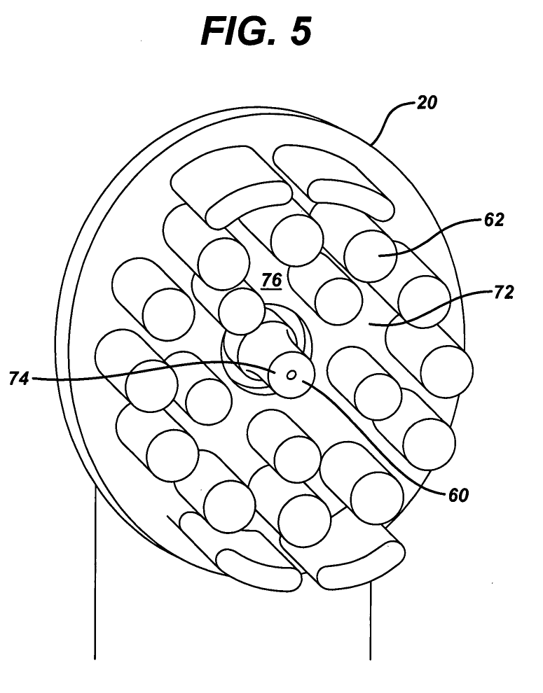

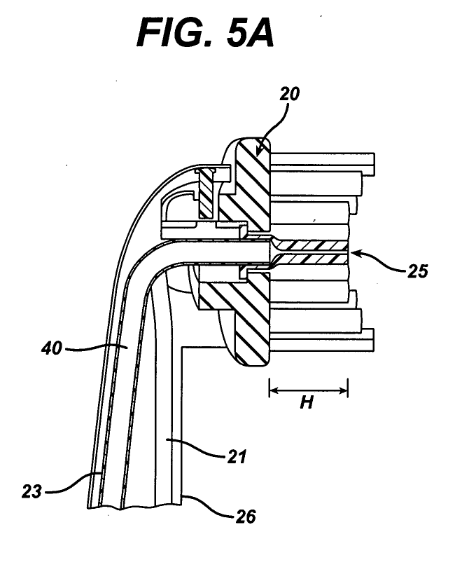

As noted above, oral care device 12 is in the form of a power toothbrush that includes a movable head. Movement of the head is accomplished using a motor (not shown) that drives a drive shaft 21 (FIG. SA), which in turn moves (e.g., rotates or oscillates) the head 20. The drive shaft 21 is connected to the head 20 using an offset design that facilitates central placement of a fluid outlet 25 at the head 20 and a tube 23 that terminates near the outlet 25 (FIG. 5A). Tube 23, positioned in the neck 26 of the oral device, forms a portion of a fluid passageway 40 within the oral care device 12 that is in fluid communication with exit line 16. A suitable head drive assembly is described, for exampje, in pending U.S. patent application Ser. No. 10/861,253, filed Jun. 3, 2004, which is incorporated herein by reference. In some embodiments, the oral care device has a stationary head or a combination of a stationary head portion and a movable head portion.

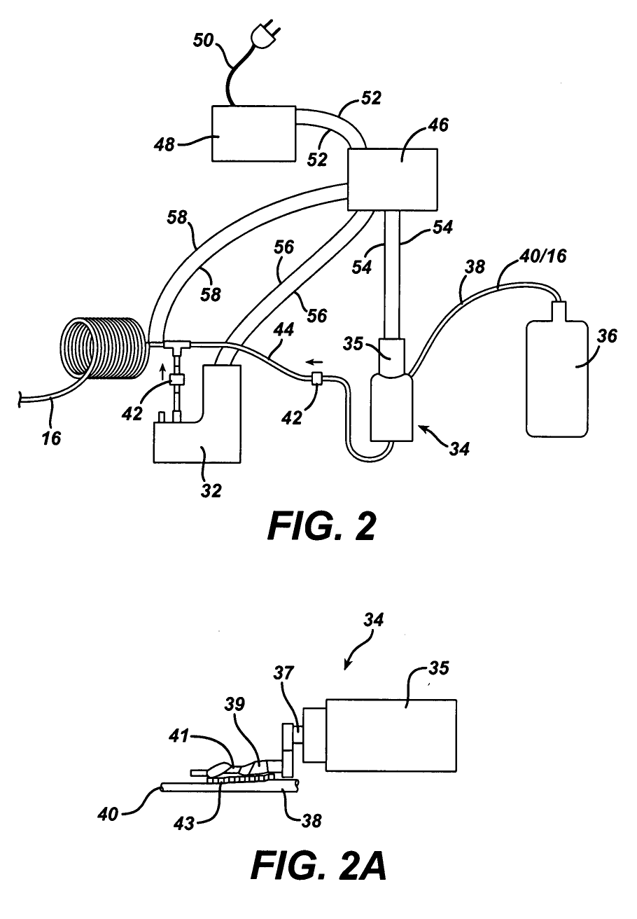

Docking station 14 includes a docking portion 28 to which the oral care device can be docked and a housing portion 30. Referring to FIG. 2, within housing portion 30 are a pump assembly 34 suitable for pumping liquid, a compressor 32 suitable for providing pressurized air, and a fluid reservoir 36. The fluid reservoir may have any desired volume. In some implementations, the reservoir is designed to contain sufficient liquid for 2-6 weeks of regular use. Thus, assuming a flow rate of 0.5 to 10 ml/min, a brushing time of 1-2 minutes/treatment, and regular use twice per day, the reservoir may be designed to contain 1400 to 1700 ml. However, to maintain a relatively small footprint for the docking station, it may be desirable to use a smaller reservoir, e.g., about 200 to 500 ml.

Referring now to FIG. 2A, the pump assembly 34 is a finger pump assembly that includes a motor 35 capable of rotating a rotatable shaft 37 that is connected to a screw 39 having an advancing spiral 41 of enlarged dimension. The screw 39 and spiral 41 are shaped to sequentially displace each finger 43 of an array of interconnected fingers, linearly, as the motor 35 rotates the screw 39. The fingers 43 form a series of cantilevered projections that are positioned adjacent to a compressible member, which in this case is formed by a portion of tube 38 that, itself, forms a portion of fluid passageway 40. When the fingers are displaced, they compress the compressible member progressively along its length (e.g., peristaltically) in a series of multiple compression events to force fluid along the fluid path. A suitable finger pump assembly is described in greater detail in U.S. patent application Ser. No. 10/861,253, already incorporated by reference. While a finger pump assembly is described above, any suitable pump assembly can be employed (e.g., a diaphragm pump or a piston pump).

Referring back to FIG. 2, the pump assembly 34 draws fluid from the fluid reservoir 36, through the exit line 16, and along the fluid passageway 40. Tube 38 is connected to a one-way check valve 42 through which the fluid passes into tube 44, also connected to the check valve 42. The check valve 42 inhibits back flow of fluid due to pressurized air within the fluid passageway 40 generated by the compressor 32. The exit line 16 is preferably sufficiently long so that the user may comfortably maneuver the oral care device, and yet sufficiently short so that there is not an excessive pressure drop between the compressor outlet and the nozzle. Generally, it is preferred that the pressure drop be less than about 5 psi, and that the overall length of the exit line be less than about 200 cm, e.g., from about 100 to 175 cm, measured from the point at which the exit line enters the docking station to the point at which it enters the oral care device 12. A suitable exit line for use with a liquid flow rate of 4 ml/min and an air flow rate of 4 liters/min, for example, would be a tube having an inner diameter of 0.0625 inch and a length of 120 cm, terminated by a 0.020 inch diameter nozzle.

The pump assembly 34 forces a controlled amount of liquid (e.g., between about 0.5 and 20 milliliters per minute, typically between about 2.5 and 5.0 milliliters per minute) into the pressurized air stream in the passageway 40 downstream of the compressor 32. The pressurized air stream may be pressurized, for example, to a pressure between about 5 and 25 psi. In some embodiments, the mixing of the air and liquid takes place in a compressor, which is described in further detail below.

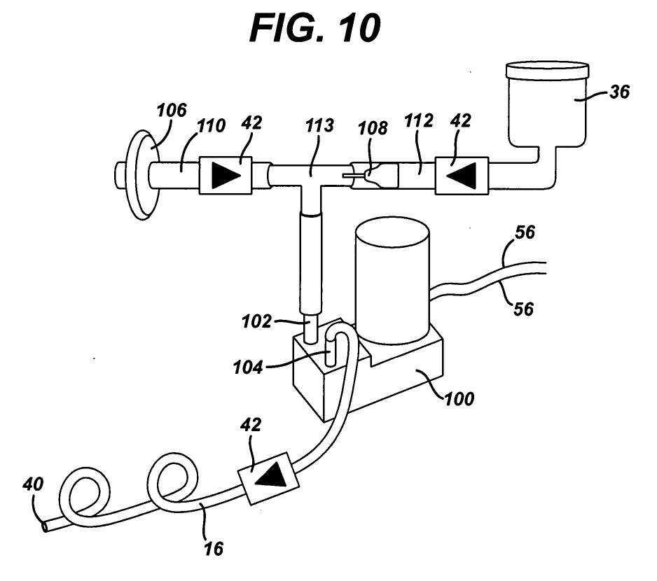

Preferably, once the liquid and air are combined, the air is directed along the passageway at a rate of between about one and ten liters per minute, while the liquid flow rate is between about one and six milliliters per minute, such as about 4 milliliters per minute. Any suitable compressor can be used (e.g., diaphragm, piston), including those utilizing alternating current or direct current. A compressor utilizing alternating current may have certain advantages, such as not requiring an AC-DC converter. If a diaphragm pump is used, this may facilitate drawing liquid into the compression chamber, eliminating the need for a separate liquid pump (see FIG. 10, for example). A DC compressor may have certain advantages, such as relatively less heat generation. A suitable compressor is a dual diaphragm air compressor, powered by a 12V DC brush motor, at 1.3 amps, capable of 11 psi with about 3.8 liters/min flow when terminated with a 0.020 inch diameter nozzle. The compressor and motor are preferably capable of running at higher voltages to achieve higher outputs. The compressor mass is preferably less than 227 grams. It may be desirable in some embodiments to include a muffler on the compressor intake in order to minimize noise and filter incoming air.

Referring again to FIG. 2, the compressor 32 and pump assembly 34 receive power and control signals from an electronic circuit 46 and an associated power transformer 48. The transformer 48 can be plugged into a conventional AC power outlet using a power cord 50 and provides power to the electronic circuit through leads 52. Power and control signals are relayed through leads 54 and 56 to the pump assembly 34 and compressor 32, respectively. Leads 58 connect the oral care device 12 to the electronic circuit 46 and permits user interface with the electronic circuit, such as to turn the system on and off. It is generally preferred that the power requirements of the system not exceed 20 W, and in some cases not exceed 15 W.

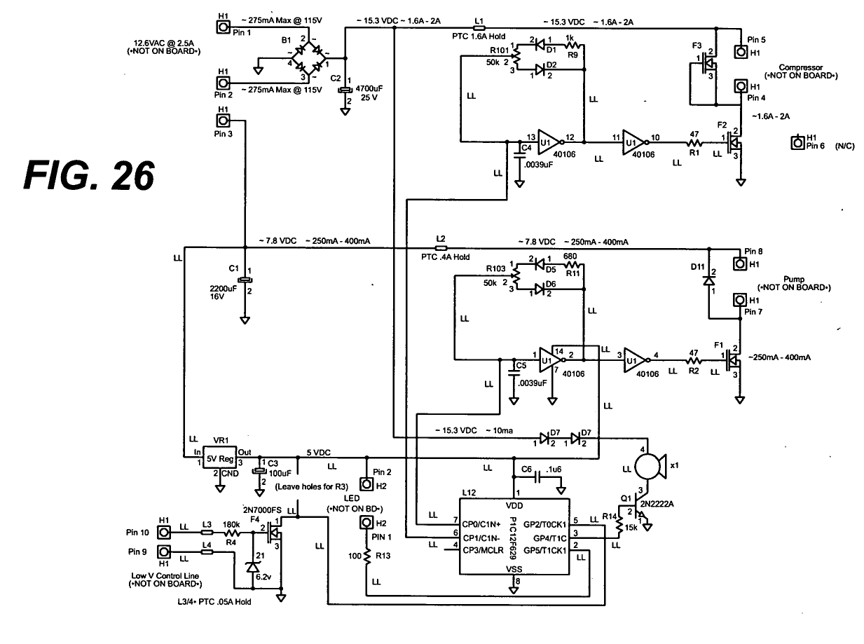

A suitable electronic circuit 46 is shown in FIG. 26. This circuit includes several safety features which provide electrical isolation and thus minimize the potential for shock should the oral care device or docking station be immersed in water during use. For example, a 0.05 amp PTC (positive temperature coefficient thermistor) is provided on the wires L3 and L4 to the brush handle. The brush handle connects to pins 9 and 10. The compressor and liquid pump also include 1.6 and 0.4 amp PTCs, respectively.

In some embodiments, electrical communication is provided between the docking station and the device in a manner that allows signals to be exchanged between the device and the docking station. For example, generally the system is configured so that turning the power on and off will automatically activate and deactivate the compressor, and docking the device will automatically activate recharging and, if applicable, refilling, according to the configuration. If desired, more sophisticated signal exchange may be provided. For example, the docking station and/or the device may be configured to provide the user with feedback, e.g., with an indication of brushing time, brushing pressure, liquid remaining in the reservoir, liquid and/or air flow rate, and/or other parameters. This electrical communication may be wireless, or may be via leads within exit line 16. The information may be displayed on the device and/or on the docking station, and in some cases may be stored in the docking station for future reference by the user, for example to provide the user with a record of brushing times during brushing sessions over a period of time.

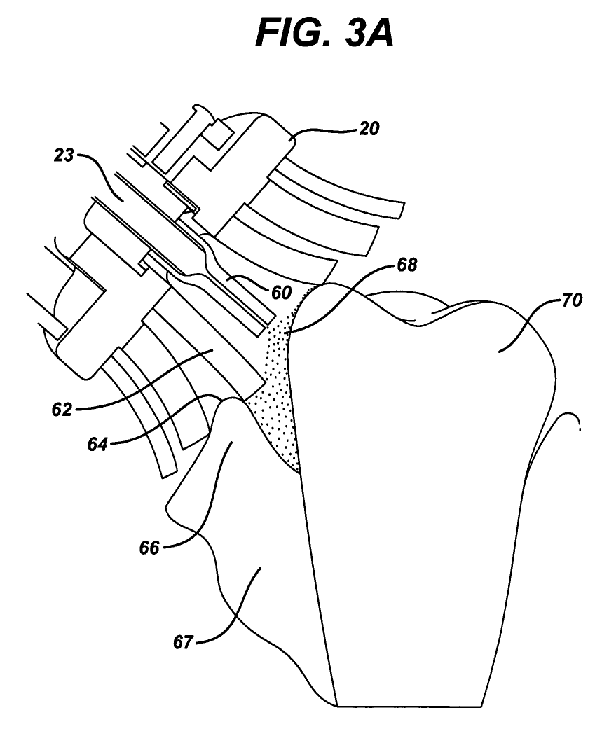

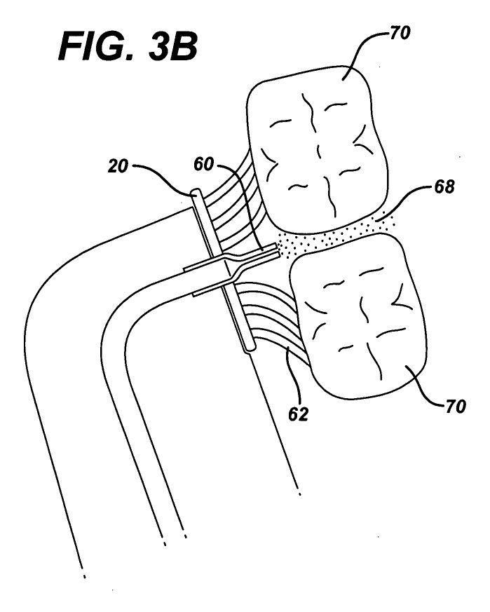

In use, the air-liquid combination is directed to the oral care device 12 through exit line 16 and tube 23, and is ejected at outlet 25 through a nozzle 60 located at the head 20. Referring to FIGS. 3A and 3B, the nozzle 60 is designed to direct the air-liquid combination 68 (e.g., in the form of a spray) beyond distal ends of adjacent bristle tufts 62 while the bristles are in contact with the teeth 70 and/or gums 67 of a user. In some implementations, the air-liquid combination 68 may be ejected at a rate that can open gingival margin 64 to expose the sulcus 66, which is the subgingival area from the gingival margin to the junctional epithelium (see FIG. 3A). Opening the gingival margin 64 can promote access to the sulcus 66 for cleaning and treatment delivery. Exposure of the sulcus 66 also facilitates cleaning of the exposed region with the bristles. Referring particularly to FIG. 3B, the air-liquid combination can also be ejected at a rate that will cause the air-liquid combination to pass through the interproximal area between adjacent teeth 70 for cleaning and treatment delivery. In some implementations, the air-liquid combination 68 is ejected in the form of a spray formed of nebulized liquid carried by a stream of air.

To form an air-liquid combination, a suitable liquid (or combination of liquids) is chosen.

The liquid is chosen in part based on the rheological characteristics that are required to deliver the air-liquid combination at a desired rate and pressure using a given pump and pressure arrangement. Preferred liquids have sufficiently low viscosity, or are sufficiently shear-thinning, so that they can be sprayed under the desired conditions. Preferably, the liquids are shear-thinning, exhibiting rapid changes of viscosity when sheared to facilitate spraying. Generally, the surface energy properties of the liquid should be of a magnitude that will minimize or prevent bubble formation, i.e., preferred liquids are non-foaming or low foaming. Preferred liquids generally have rheological properties that allow any insoluble material to be suspended in the liquid, and have sufficient cohesion and surface energy properties to allow droplets to form in the shear conditions provided by the oral care device. Suitable liquids are described, for example, in U.S. patent application Ser. No. 10/871,659, filed on Jun. 18, 2004, the complete disclosure of which is incorporated herein by reference.

In some implementations, the liquid will be provided in the form of an oil-in-water emulsion, in which case it will generally include one or more emulsifiers, e.g., as described in the above-referenced patent application, U.S. Ser. No. 10/871,659. Suitable emulsifiers include, for example, ethoxylated fatty esters and oils, monoglycerides and derivatives thereof, sorbitan derivatives, glycerol esters, ethoxylated fatty alcohols, and block copolymers. The liquid may also include one or more thickeners, particularly if the liquid contains particles that need to be suspended. Suitable thickeners for this purpose include, for example, thickeners that develop a zero shear viscosity and yield point, such as synthetic hectorites and silicates, and natural, synthetic and modified gums. Examples of suitable thickeners are described in the above-referenced patent application.

An example of a suitable liquid is the following liquid toothpaste formulation:

| Ingredient | % By Weight |
|---|---|
| Water, Purified | 66.91 |
| Laponite D | 1.0000 |
| (Hydrous Sodium Lithium Magnesium Silicate) | |
| Xanthan Gum, USP/NF - Keldent | 0.2000 |
| Sorbitol Solution, 70% USP | 20.0000 |
| Glycerin, 99.5% USP, Glycon G100 | 10.0000 |
| Sodium Saccharin, USP, Syncal S | 0.0400 |
| Methylparaben NF, Nipagin M | 0.0600 |
| Propylparaben NF, Nipasol M | 0.0400 |
| Polysorbate 20 - NF Polyoxyethylene | 1.0000 |
| 20 Sorbitan Monolurate, Glycosperse | |
| Quest Flavor TP8672 | 0.7500 |

In some embodiments, the liquid is formulated to provide certain clinical advantages (e.g., similar to those provided by toothpaste), such as plaque, tartar, gingivitis and caries control and protection, as well as malodor and remineralization benefits. Thus, the liquid can serve as a replacement for dentifrice. In other cases, the liquid can be formulated for secondary use (e.g., use in conjunction with toothpaste), in which case it may provide some or none of the clinical advantages of dentifrice. The liquid may also be formulated to provide desired aesthetic properties, such as an extra feeling of cleanliness and freshness, like the feeling experienced after a dentist office cleaning, gum stimulation and tooth whitening.

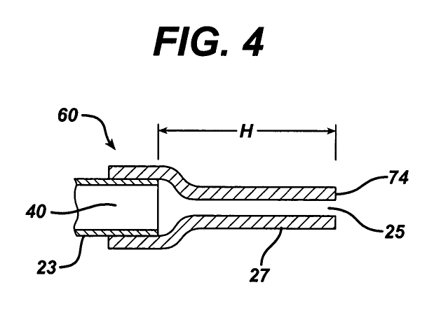

Any suitable nozzle design can be employed that is capable of delivering the air-liquid combination beyond the distal ends of the bristles. Referring to FIG. 4, a nozzle 60 includes a stainless steel tube 23, over the end of which is placed a soft silicone tube 27. The silicone tube 27 stretches over the stainless tube 23 such that it forms a seal. The height, H, from the distal end of the stainless steel tube 23 to the distal end 74 of the silicone tube 27, is adjustable, and depends on the brush head design. The air/liquid combination (not shown) flows through the fluid passageway 40, and exits the outlet 25. In some embodiments, the nozzle 60 is in the form of a tube having an inner diameter selected to provide a construction suitable to propel the air-liquid combination beyond the bristle ends during brushing, e.g., between about 0.2 mm to about 0.8 mm, such as about 0.5 mm. Referring now to FIG. 5, the nozzle 60 extends outwardly beyond base 72 from which the bristle tufts 62 extend. The height H (FIG. 5A), measured from an upper surface 76 of the base 72 to a distal end 74 of the nozzle 60, can vary from being equal to the bristle's height (e.g., about 10 mm) to being recessed to the upper surface 76 of the base 72 of the brush head shown in FIG. 5. The closer the nozzle is to the tooth/gum surface, the more impact the spray will have on a small localized area, while the further away the nozzle gets, the broader the area of coverage will be. The spray from longer nozzles will also tend to be less interfered with by the bristles. In some embodiments, H is about five millimeters. In most implementations, the manufacturer will preset the nozzle height; however, in some implementations the nozzle height may be adjustable by the consumer. For example, the nozzle may be fixed and the brush head may be configured to move up or down with a twist of the head along a spiral incline with indents that locks the head into different height positions relative to the nozzle.

Depending on the height H of the nozzle 60, in some embodiments, the nozzle may contact the teeth 70 and/or gums 67 during use. Preferably, the nozzle 60 is flexible. At least a portion of the nozzle may be formed of a soft, flexible material (e.g., an elastomeric material such as silicone elastomer) to provide comfort during use and to render the presence of the nozzle relatively imperceptible during brushing. In such cases, it is generally preferred that the flexible material have a hardness of less than 80 Shore A, preferably less than 70 Shore A, more preferably from about 45 to 65 Shore A. However, if desired the nozzle or a portion of the nozzle may be rigid or semi-rigid.

In embodiments in which nozzle 60 contacts the teeth, this contact can lead to intermittent blockage of the nozzle resulting in intermittent pressure buildup in the system. To relieve such intermittent pressure buildup, inline pressure relief valves may be included. A relief valve may be placed in the air line, after the compressor and before the liquid injection point, in those cases where liquid is not drawn into the compressor. This relief valve would be vented to the atmosphere. In these cases another relief valve may be placed in parallel to the liquid pump to recirculate the liquid should the liquid line become blocked. This arrangement generally will not work when air and liquid mix inside the compressor, because it is not acceptable to vent the liquid inside the housing. In this case, a preferred solution to intermittent blockage pressure spikes is to design all connections and components to withstand the system's maximum pressures without deleterious effects.

Bristle tufts 62 extend from the base 72. Although each tuft is shown as a solid mass in the drawings, the tufts are actually each made up of a great mass of individual plastic bristles. The bristles may be made of any desired polymer, e.g., nylon 6.12 or 6.10, and may have any desired diameter, e.g., 4-8 mil. The tufts are supported by the base 72, and may be held in place by any desired tufting technique as is well known in the art, e.g., hot tufting or a stapling process. The tufts may also be mounted to move on the base 72, as is well known in the toothbrush art.

Generally, tufts 62 and nozzle 60 may be positioned where desired. Referring still to FIG. 5, tufts 62 are positioned about centrally located nozzle 60. As shown, a relatively circular head design is illustrated where base 72 is in the form of a circle. The nozzle 60 is shown positioned at about the center of the elliptical base 72, coextending with an axis of rotation of the head with the tufts arranged about the nozzle 60 in a circular arrangement. In some embodiments, the oral care device includes an elliptical head design with the nozzle positioned at the center of an elliptical base (i.e., the intersection of the major and minor axes of the elliptical base) with the tufts positioned about the nozzle in an elliptical arrangement.

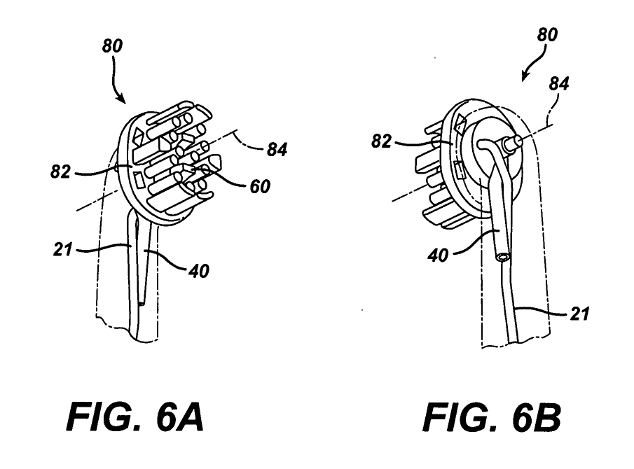

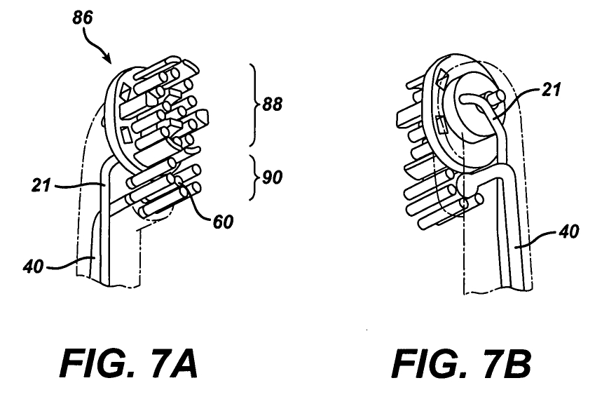

It is not required, however, that the nozzle be positioned centrally or that the nozzle coextend with the axis of rotation 78 of the head. For example, referring to FIGS. 6A and 6B a movable head 80 includes an offset nozzle design. An offset nozzle may offer certain advantages, for example better access to specific sites within the oral cavity, and a sweeping motion of the nozzle for greater area coverage. In this embodiment, a nozzle 60 and associated fluid passageway 40 extend through a base 82 spaced from an axis of rotation 84. As another example, referring to FIGS. 7A and 7B, a head 86 includes a movable portion 88 and a stationary portion 90 with a nozzle 60 and associated fluid passageway positioned in the stationary portion. As an alternative, the nozzle can be positioned within the movable portion, as described above, rather than in the stationary portion. In some cases, the nozzle 60 is placed in a manual toothbrush having only a stationary head (e.g., at a toe of the brush).

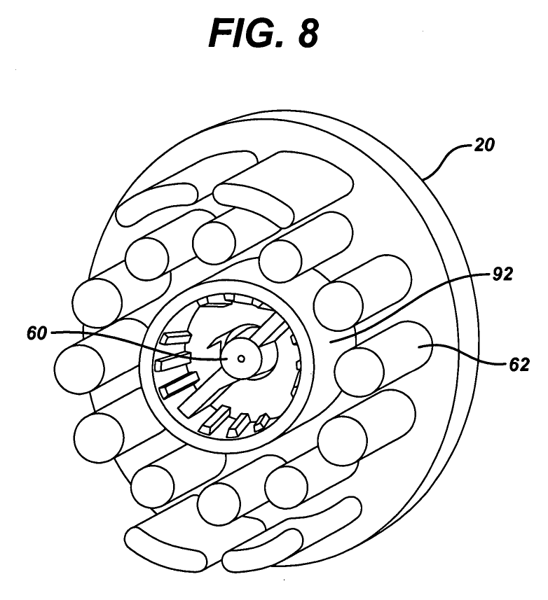

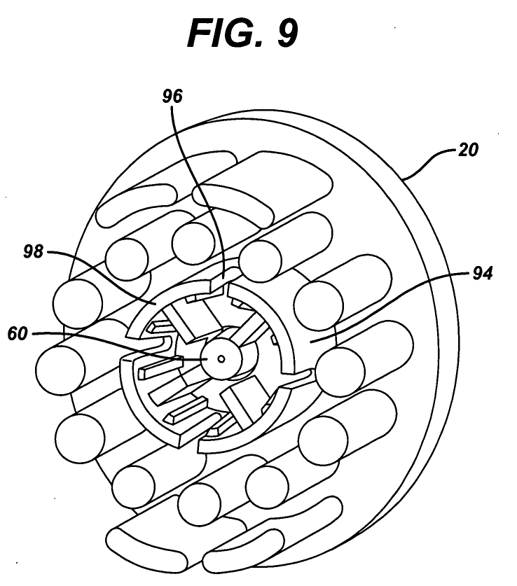

Referring now to FIGS. 8 and 9, in some embodiments, the nozzle 60 design includes a prophy cup 92, 94 (or other guiding member suitable for directing the air-liquid combination) placed in the center of the bristle field and about the nozzle 60. The prophy cup 92, 94 can aid in guiding the air-liquid combination onto the target surface (e.g., the teeth) and inhibit the bristles from interfering with ejection of the air-liquid combination. Referring to FIG. 9, a “castellated” prophy cup 94 includes openings 96 positioned along a ridge 98 of the prophy cup. The openings 96 permit the pressurized air and liquid to escape through the openings 96, which can aid in cleaning. Suitable prophy cups are described in detail in pending U.S. patent application Ser. No. 10/364,148, filed Feb. 11, 2003, which is incorporated herein by reference.

Referring to FIG. 10, another embodiment of an oral care system includes a diaphragm compressor 100 that is capable of drawing air and a liquid into an input port 102 and expel an air-liquid combination formed by combining the air and liquid within the compressor 100 out an exit port 104. Because compressor 100 is capable of drawing liquid from the reservoir 36, in this embodiment a separate liquid pump is not required. To achieve a desired air-to-liquid volume ratio (e.g., 500:1 to 8000:1), restrictors 106, 108 are used to balance respective air and liquid input lines 110 and 112. In the embodiment shown, the restrictors 106 and 108 are fixed, but in other cases either (or both) of the restrictors can be adjustable. The restrictors can be made adjustable by designing them with variable inner diameters. The liquid restrictor 108 (e.g., a stainless steel tube having an inner diameter less than an inner diameter of the input line 112) can be placed along line 112 (e.g., separate from reservoir 36) or the restrictor 108 can be connected directly to the fluid reservoir 36. The lines 110 and 112 include one-way check valves 42 to inhibit reverse flow, and are joined by a T-connector 113 that is connected to the input port 102. The exit port 104 is connected to an exit line 16 forming a portion of the passageway 40 that is connected to the oral care device. Another one-way valve 42 inhibits reverse flow back into the compressor 100. The compressor 100 is connected to power and control leads 56 and, as discussed above with reference to FIG. 2, the exit line 16 can contain power and control leads so that the oral care device can interface with the docking station.

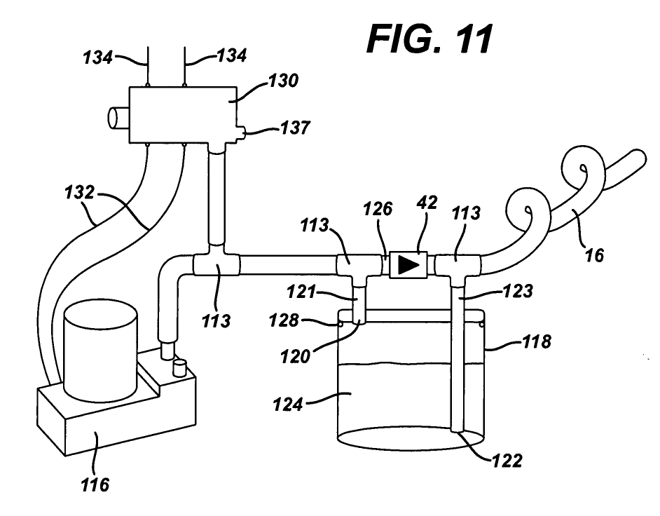

Referring to FIG. 11, another embodiment of an oral care system includes an air compressor 116 designed to simultaneously pressurize a reservoir 118 and propel an air-liquid combination through an exit line 16 connected to an oral care device. The reservoir 118 includes an inlet port 120 through which air can enter the reservoir and an outlet port 122 through which a liquid 124 can exit the reservoir. Ports 120 and 122 are formed by respective ends of conduits 121 and 123. A one-way check valve 42 is positioned along a conduit 126 connecting the inlet port 120 and the outlet port 122. During use, the one-way valve 42 causes a relatively small pressure drop so that the liquid has a pressure high enough to enter the pressurized air stream and the valve 42 also inhibits liquid from moving in a direction toward the compressor 116. Another one-way check valve can also be included downstream of the outlet port and associated connector 113. The reservoir 118 must be designed to hold the pressure (e.g., about 15 psi) and includes an O-ring seal 128 to inhibit depressurization. To bleed pressurized air from the reservoir 118 when the system is shut off (e.g., to prevent residual liquid from exiting the nozzle due to the pressurized air within the reservoir), a switch 130 is included that can simultaneously turn off the compressor 116 via electrical leads 132 and can mechanically open a vent 137 through which the pressurized air can pass. The switch 130 is electrically connected to a power supply and controller by leads 134. T-connectors 113 are used in several locations to connect conduits. The above-described configuration can eliminate a requirement for a separate liquid pump.

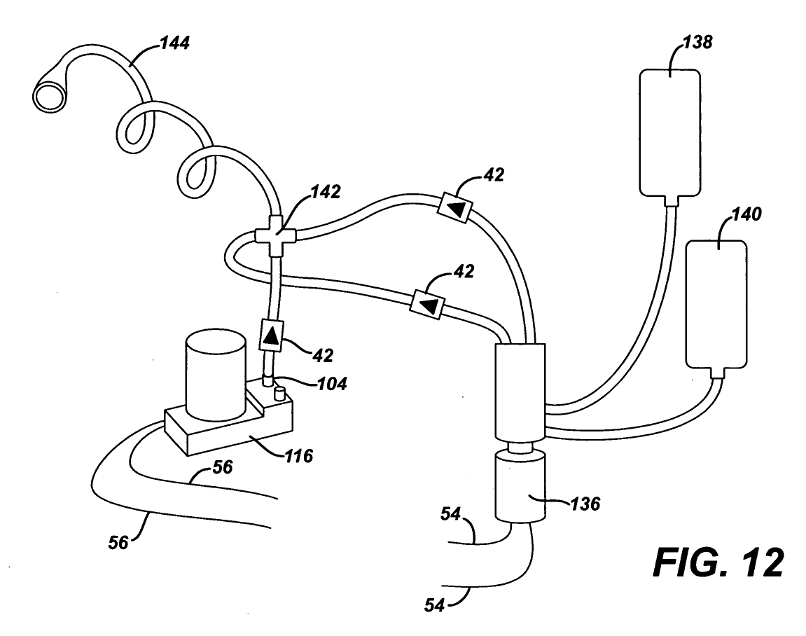

Referring to FIG. 12, an embodiment of an oral care system includes an air compressor 116 and a liquid pump 136 that permits liquid from two liquid reservoirs 138 and 140 to mix with compressed air at a cross-connector 142 prior to being expelled into a single lumen of an exit line 144 that is connected to an oral care device. One-way check valves 42 are positioned in line with an exit port 104 of the compressor 116 and the liquid pump 136 leading to the cross-connector 142, respectively, to inhibit back flow. Power and control leads 54, 56 are connected to the liquid pump and the compressor.

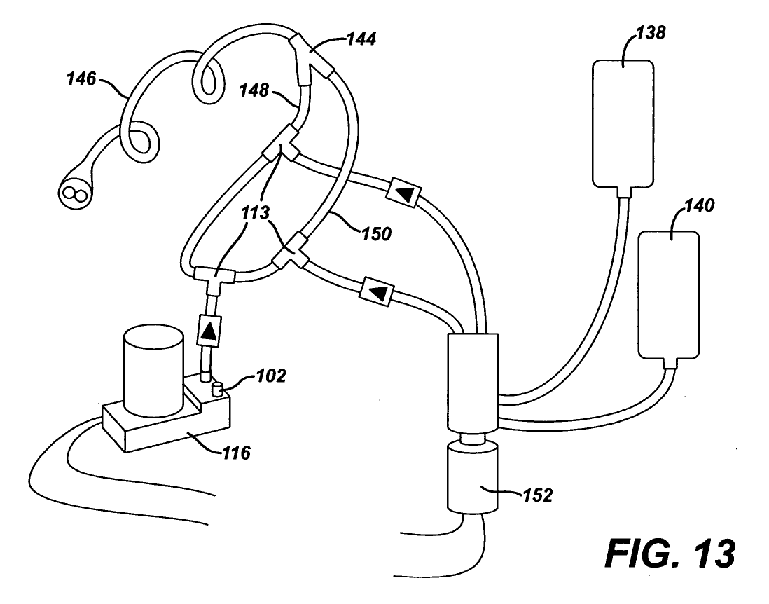

In another embodiment, referring to FIG. 13, liquids from two liquid reservoirs 138 and 140 are independently mixed with compressed air at a pair of T-connectors 113 and kept separate until they are ejected from an oral care device. This arrangement may be particularly desirable where the liquids are selected for a treatment that results from a relatively fast-acting reaction caused by combining the two liquids. A liquid pump 152 capable of pumping multiple liquids along separate fluid lines draws liquid from each of the two reservoirs 138, 140 and directs the 25 liquids toward the respective T-connectors 113. A Y-connector 144 connects a multi-lumen exit line 146 to a pair of conduits 148 and 150 such that the air-liquid combinations remain separated while moving along the multi-lumen exit line 146.

In the embodiment shown in FIG. 13, the oral care device preferably includes a head design capable of ejecting two independent air-liquid combinations (e.g., simultaneously and/or sequentially). In some cases, an input port 102 of the compressor 116 can include a filter (not shown) for filtering the incoming air and reducing compressor noise.

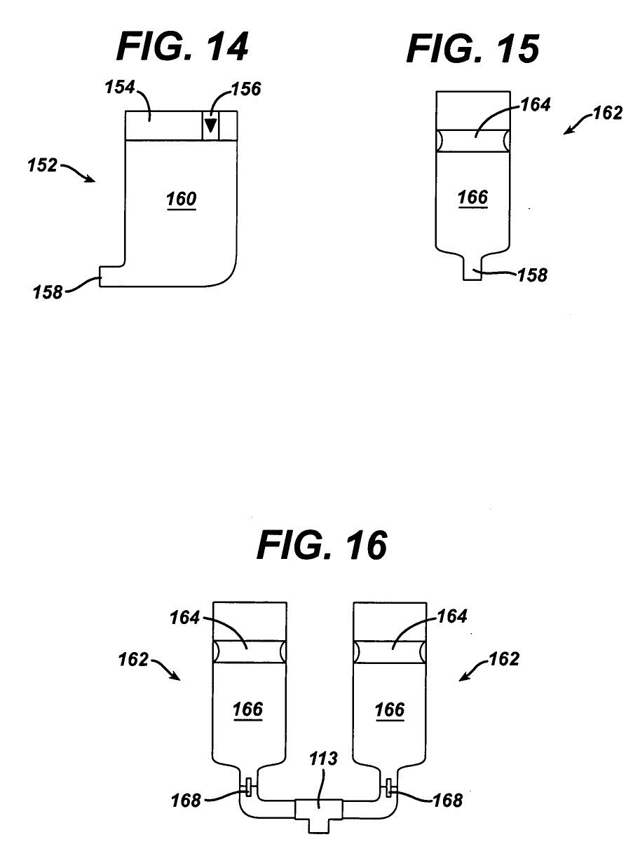

Referring now to FIGS. 14-18, various reservoir embodiments are shown. Turning to FIG. 14, a relatively rigid reservoir 152 includes a removable cap 154 that has a one-way check valve 156 and an exit port 158. Reservoir 152 can permit air to enter chamber 160 as liquid is drawn out, preventing a vacuum from forming.

Referring now to FIG. 15, another rigid reservoir 162 embodiment includes a sliding plunger 164 and an exit port 158. Preferably, the reservoir 162 includes a cylindrically shaped chamber 166 for ease of plunger design, however, other configurations are contemplated. The reservoir 162 can eliminate a requirement for a check valve (see FIG. 14) and reduces contact of air with the liquid inside the chamber 166. The reservoir 162 also can facilitate visual observation of the liquid level within the chamber 166, for example, if the reservoir is formed of a transparent or translucent material.

Referring to FIG. 16, a pair of rigid reservoirs 162, each having all the features of the reservoir shown in FIG. 15, are connected for a dual-stream oral care system. The reservoirs 162 are interconnected by a T-connector 113. A desired liquid ratio is achieved by flow restrictions 168. In some embodiments, a desired liquid ratio can be achieved by adjusting a liquid concentration level of the liquid within one or both of the reservoirs 162.

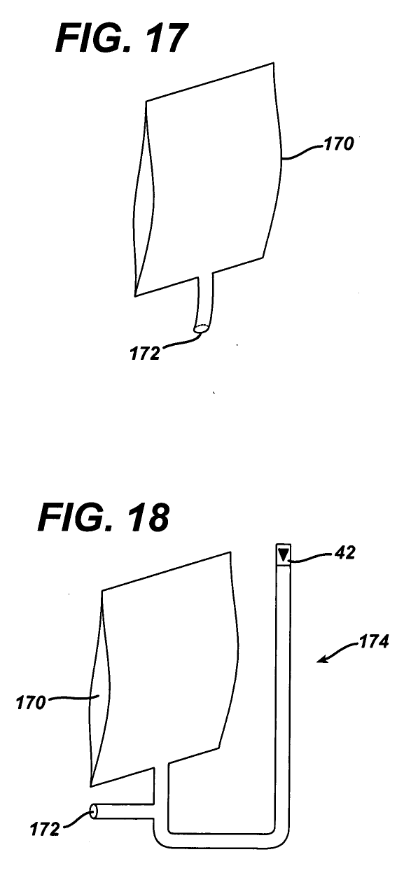

FIGS. 17 and 18 each show a flexible bag reservoir 170 including an exit port 172 that allows a liquid to be drawn out without use of a check valve (see FIG. 14) or a sliding plunger (see FIG. 15) to equalize pressure within the chamber as liquid is drawn. Reservoirs 170 can also be formed relatively cheaply and can be refillable and/or disposable (e.g., after a single use). The bag reservoir of FIG. 18 has all the features of the bag reservoir of FIG. 17, and also includes an indicator 174 for visually indicating a liquid level within the bag 170. Indicator 174 is vented through a one-way check valve 42.

In other embodiments, the oral care system may be similar to the systems described above (and may include any of the features described above), except that the exit line is omitted and the oral care system is self-contained, i.e., the compressor, reservoir and power source are included within the housing of the oral care device. In such devices, the reservoir may be disposable/replaceable, or may be rechargeable by placing the oral care device or a portion of the oral care device on a docking station.

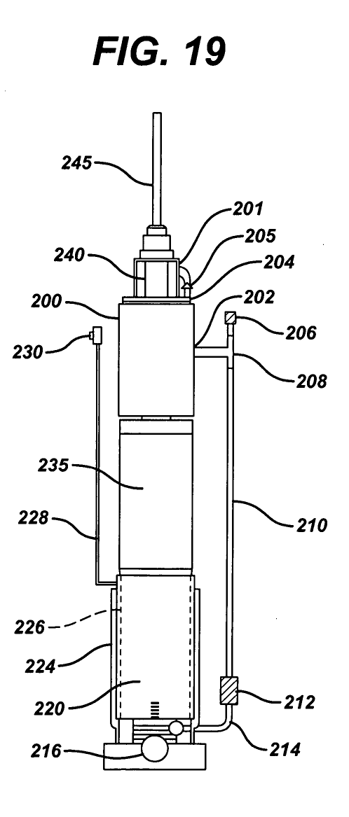

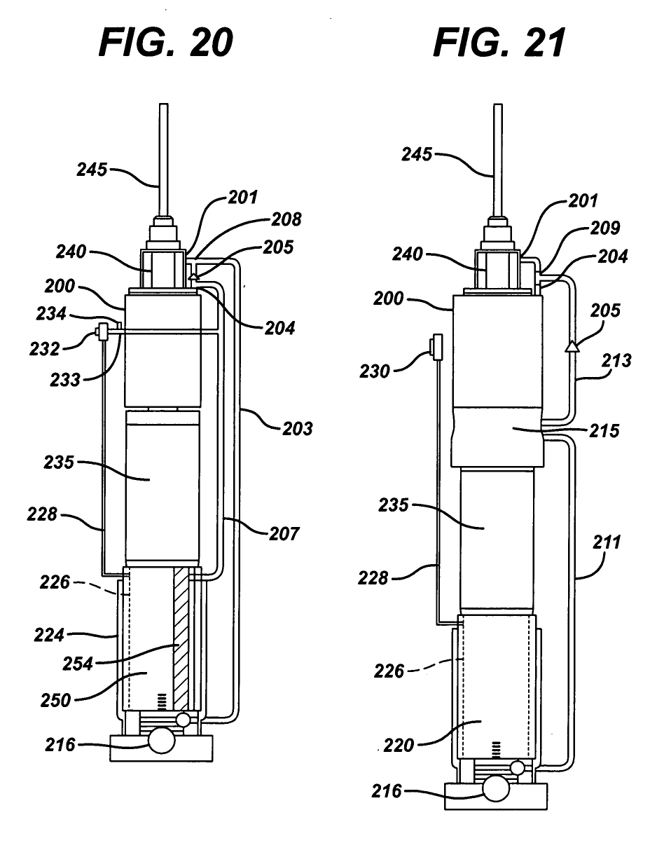

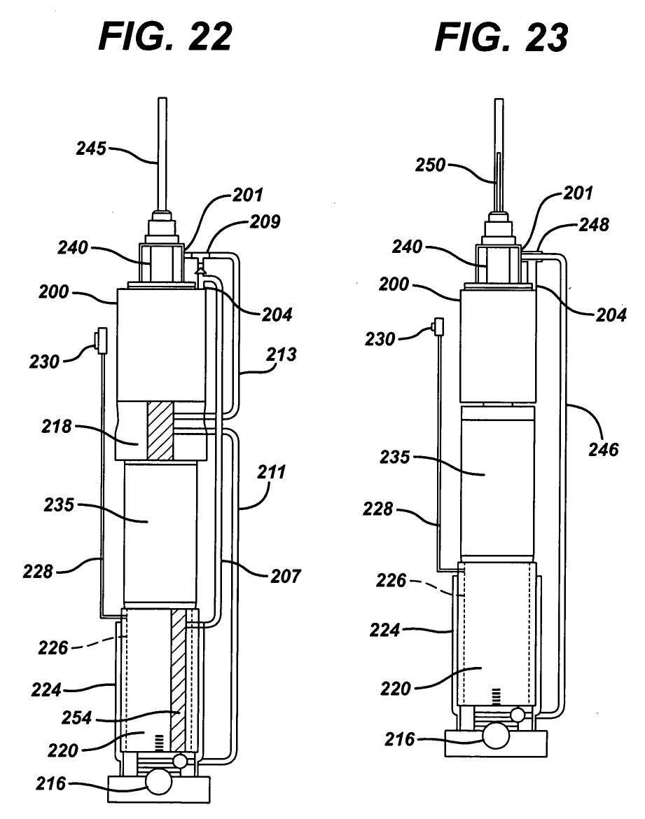

The components of various self-contained oral devices are shown in FIGS. 19-23. These self-contained devices include one in which liquid is drawn into the air compressor and co-expelled as a spray (FIG. 19), and three in which liquid is introduced into the air downstream of the compressor (FIGS. 20-23). In the embodiment shown in FIG. 20, the oral care device includes a pressurized air reservoir with a pressure release feature. In the embodiment shown in FIG. 21, the compressor and liquid pump are driven by a single motor and the reservoir is not pressurized. In the embodiment shown in FIG. 22, the air reservoir is pressurized without a pressure release. In the embodiment shown in FIG. 23, the oral care device includes a multi-lumen siphon mix with an external mix nozzle. The following is a detailed description of each of these approaches.

All five embodiments have the following features in common. A reservoir fill port 216 is provided to allow the reservoir (220 or 250) to be refilled from a docking station (similar to that shown in FIG. 1, but without an air compressor or a liquid dispensing system, other than what is needed to refill the reservoir). Self-aligning, high pressure seals may be provided between the docking station and the oral care device at port 216, e.g., as described in already incorporated U.S. patent application Ser. No. 10/861,253. Preferably the reservoir contains a sufficient volume of liquid to deliver liquid throughout a 2 minute brushing cycle, e.g., at least 10 ml. A set of control wires 228 runs from an on/off switch (230 or 232) to a PCB control board 226 (shown with dashed lines to represent its position behind the reservoir). Power is supplied by batteries 224. The current and power requirements for driving the compressor are relatively high (typically about 1.3 amps current and 10 watts power), and thus it is generally preferred that batteries 224 be rechargeable lithium ion batteries. If rechargeable batteries are used, the docking station is generally configured to recharge the batteries while the oral care device is docked. Another configuration is to have a removable battery and/or liquid reservoir cartridge that can be separated from the oral care device for charging and/or refilling outside the device housing, e.g., as discussed in the Other Embodiments section, below. At the top of a compressor 200 there is a drive shaft (245 or 250) with a coupling 240 that drives the brush head (not shown). In the embodiments shown in FIGS. 19-22, the same motor 235 drives both the compressor and the brush head. The drive shaft is hollow to perform the dual function of driving the brush head and providing a conduit for the air/liquid mix.

Referring to FIG. 19, in this embodiment liquid is drawn from the reservoir 220, through a tube 214, then a flow restrictor 212, and then through another tube 210 into the diaphragm compressor 200 at the compressor's input 202. At the same time, air is drawn into the compressor through a flow restrictor 206. The air and liquid mix inside of a junction 208 just prior to entering the compressor 200. Selection of the two flow restrictors 206 and 212 will determine the air/liquid ratio sprayed out the system. A typical ratio is 875:1 air/liquid. Suitable air/liquid ratios may be in the range of 200:1 to 8,000:1, where each quantity is measured in ml/min. Because liquid is drawn into the air chamber of the air compressor, in this embodiment it is preferred that a diaphragm compressor be used to prevent liquid from leaking. A suitable diaphragm compressor is described above. The air/liquid combination flows inside the compressor and exits the output port 204. The combination flows past a one-way check valve 205, then through a manifold 201, then through the drive shaft 245, and finally to the brush head (not shown).

Referring now to FIG. 20, this embodiment uses the compressor 200 to simultaneously provide pressurized air as part of the spray, as well as to pressurize an air reservoir 254 to force liquid into the air stream. Air flow exits the output port 204, and goes through conduit 207 to pressurize the air reservoir 254. The air reservoir expands and squeezes liquid from the flexible reservoir 250, forcing it through conduit 203, and into the air stream at the junction 208. The air exits through a port 204, and flows across a one-way check valve 205. Check valve 205 serves two functions: it prevents back flow, and also provides a small pressure drop to ensure that the liquid pressure is slightly higher than the air pressure, thus allowing the liquid to flow into the air head pressure. The air-liquid combination then flows through manifold 201, then through the drive shaft 245, and finally to the brush head (not shown).

Because the air reservoir 254 retains pressure upon device shut-off, liquid could continue to dispense from the brush head if the pressure were not relieved. Therefore, a bleeder valve 234 is connected to the on/off switch 232 to vent the air reservoir 254 through the conduit 207. The bleeder valve 234 remains closed when the device is on, and opens when the device is turned off.

Referring to FIG. 21, in this embodiment compressor 200 and liquid pump 215 are both driven by a single motor 235. The motor 235 also drives the brush head (not shown). In this embodiment, the compressor 200 may be, for example, a diaphragm, piston, or CEM type compressor. The liquid pump 215 may be, for example, a peristaltic, screw, gear, bellows, or bladder pump. The liquid pump can also be incorporated into the housing of the air compressor 200, as opposed to being a separate external part as shown.

Still referring to FIG. 21, the liquid pump 215 draws liquid from the liquid reservoir 220, through a conduit 211 and then out of the liquid pump 215 through another conduit 213, past a one-way check valve 205, and into the air/liquid junction 209. Air exits the air compressor 200 at the exit port 204 and mixes with the liquid at the air/liquid junction 209. The air/liquid combination flows through manifold 201, then through the drive shaft 245 and finally to the brush head (not shown).

Referring now to FIG. 22, this embodiment includes a combination of the features discussed above with reference to FIGS. 20 and 21. The pressurized air from the air compressor 200 flows through a conduit 207 to pressurize an air reservoir 254. The pressurized air reservoir expands and forces liquid out of the flexible reservoir 250, through a conduit 211. The liquid then goes through a liquid pump 218 that also serves as a flow regulator. The liquid pump 218 forces liquid through a conduit 213 and into the air stream at the air/liquid junction 209. Air flows out of the air compressor 200 at the air exit port 204 and across a one-way check valve 205. The air then mixes with the liquid in the air/liquid junction 209. The air/liquid combination flows through manifold 201, then through the drive shaft 245 and finally to the brush head (not shown). The liquid pump/flow restrictor 218 prevents liquid from flowing out of the brush head once the device is shut off, while the air reservoir 254 remains pressurized. Since the liquid reservoir 250 cannot be filled if the air reservoir 254 is pressurized, an air vent (not shown) is included in the reservoir fill port 216 so that the air vents from the air reservoir 254 upon connecting the port 216 to a docking station for liquid filling.

Referring to FIG. 23, the primary distinction between this embodiment and those shown in FIGS. 19-22 is that in this design the air and liquid remain separate until they exit the nozzle in the brush head. This is accomplished by the use of multi-lumen tubing in which some of the lumens only carry air, while others only carry liquid. The nozzle tip is designed so that as the air exits it creates suction in the liquid line, which causes the liquid to be drawn without the need of a pump or pressurized reservoir.

Still referring to FIG. 23, the air compressor 200 flows air from the exit port 204 into a junction 248 which leads into an air conduit connection for a multi-lumen tube (not shown), which is in the brush head. The junction 248 also leads to manifold 201 and then through the drive shaft 250 and finally to the brush head (not shown). This drive shaft is different than those shown in FIGS. 19-22 in that it contains a central tube that conducts either the air or liquid, while the surrounding tube is the conduct for the opposite fluid, i.e., liquid or air, respectively. The brush head (not shown) has a seal that keeps the two conduits separate, and that sealingly connects the conduits to the multi-lumen tubing so that the air and liquid remain separate until they exit the nozzle tips. The liquid flows from the reservoir bag 220 through a conduit 246 and junction 248 and out the manifold 250 to the brush head (not shown). The liquid flows under the force created by suction as the air flows over the liquid line nozzle tip.

In self-contained devices, it is generally important that the reservoir be capable of delivering its contents regardless of the orientation of the oral care device. This may be accomplished, for example, by providing a piston or follower within the reservoir, opposite the reservoir outlet, which maintains contact with the liquid as liquid is exhausted from the reservoir.

The plunger or follower should generally maintain a leak-tight seal against an inner wall of the reservoir, while having relatively low frictional resistance so that the plunger or follower can easily move towards the outlet as liquid is drawn out of the reservoir.

Another method of dispensing independent of brush orientation is to use a flexible liquid reservoir that is connected to the input of a diaphragm air compressor. In this case, suction collapses the reservoir as liquid is drawn into the compressor along with the air. Alternatively, the flexible reservoir may be surrounded by a pressurized air reservoir, which applies pressure to the flexible liquid reservoir and forces the liquid out downstream of the outlet of the air compressor.

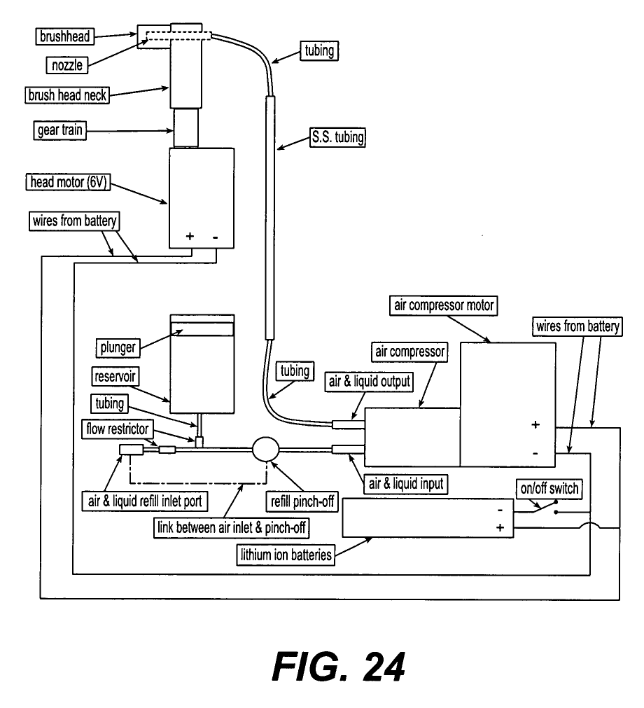

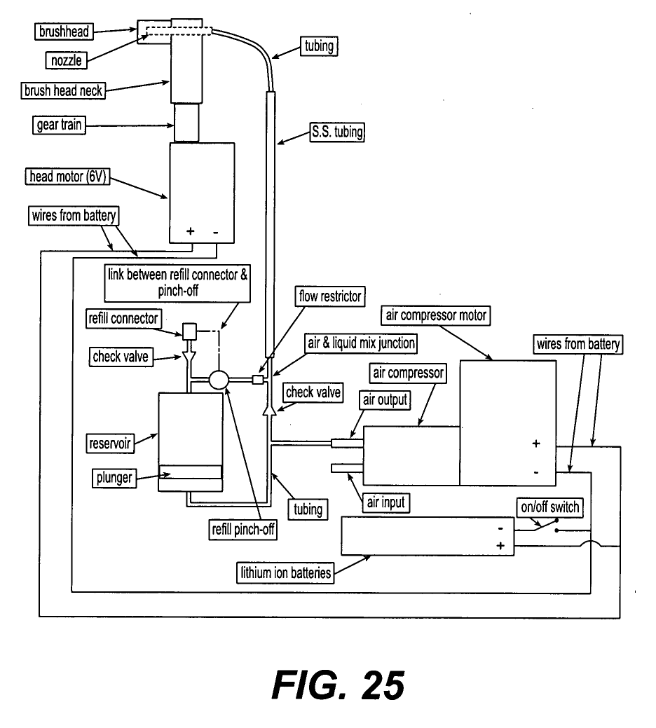

For example, FIGS. 24 and 25 are schematic diagrams showing the alternative embodiments discussed above. In these embodiments, liquid is dispensed from the oral care device without the use of an independent liquid pump. The oral care device shown in FIG. 24 uses the suction created by the input side of the diaphragm air compressor to draw liquid from the liquid reservoir while the compressor is drawing in air. In this embodiment, there should generally be a balance between the air and liquid, which means that the resistance to the air and liquid flows are designed to achieve a specified ratio of air-to-liquid. This can be accomplished by inserting conduits of specific inner diameter and length in each flow path to balance the flows to the desired ratio. In addition, the liquid should be chemically compatible with the materials it will contact within the pump. In the oral care device shown in FIG. 25, the air pressure produced by the air compressor pressurizes the liquid reservoir and forces the liquid out downstream of the outlet of the compressor. The approach shown in FIG. 25 does not require a diaphragm compressor, and permits the use of liquids that may be incompatible with the compressor, e.g., abrasive-containing liquids. Both approaches may be advantageous in self-contained oral care devices, where space within the device is limited.

In the self-contained oral care devices described above, the volume of the liquid reservoir is generally about 5 to 20 ml, which is typically sufficient for one to two treatments. This volume allows the device handle to be relatively small, for ergonomic considerations. A larger reservoir may be used if desired.

The self-contained oral care devices described above may include any of the features described with respect to the oral care device shown in FIG. 1. For example, the self-contained oral care devices may provide user feedback regarding brushing time, liquid level in the reservoir, and/or other parameters.

It is generally preferred that the oral care devices described herein be relatively small, to allow for easy storage in a user's bathroom, and to provide an ergonomic handle design. For example, it is generally preferred that the docking station have a footprint area of less than about 200 cm², and that the total volume of the docking station and the oral care device (including the exit line) be less than about 3200 cc. The applicator (handle) of the oral care device (exclusive of the exit line, if one is included) will preferably have a volume of less than 200 cc.

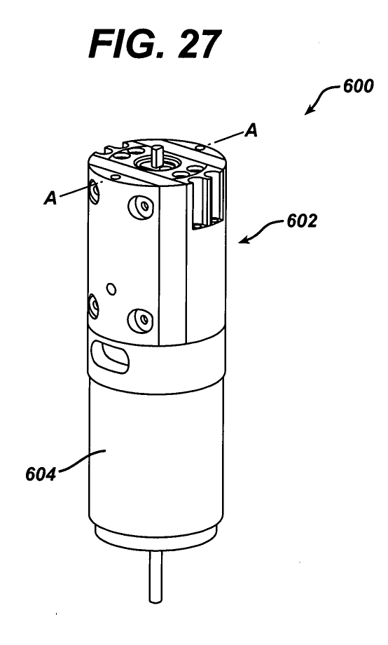

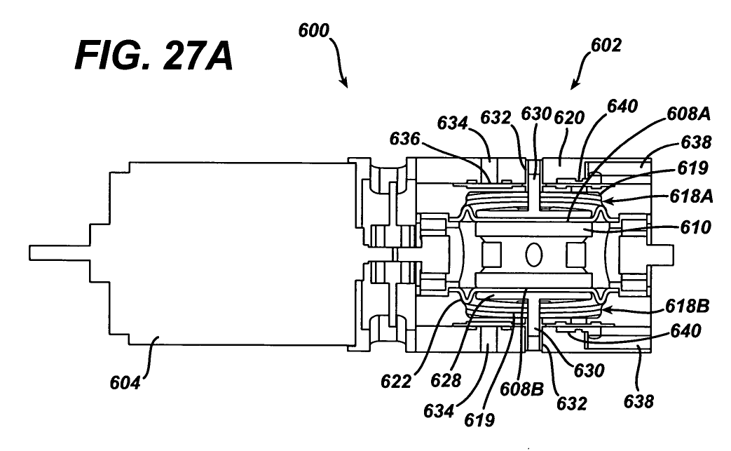

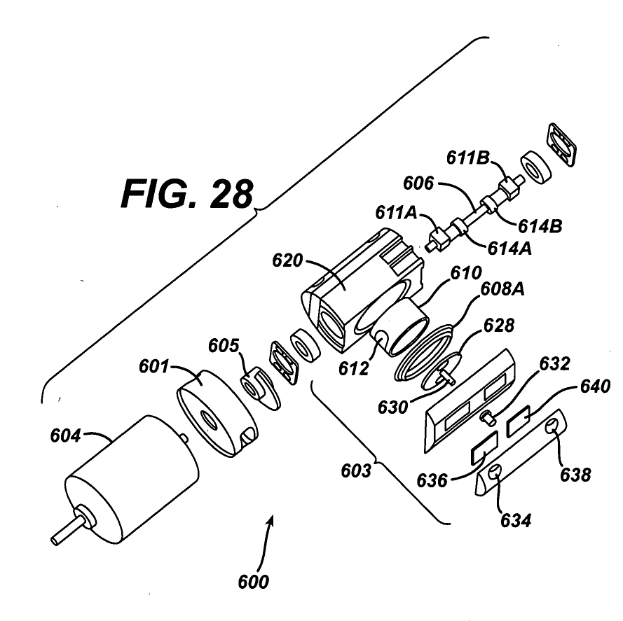

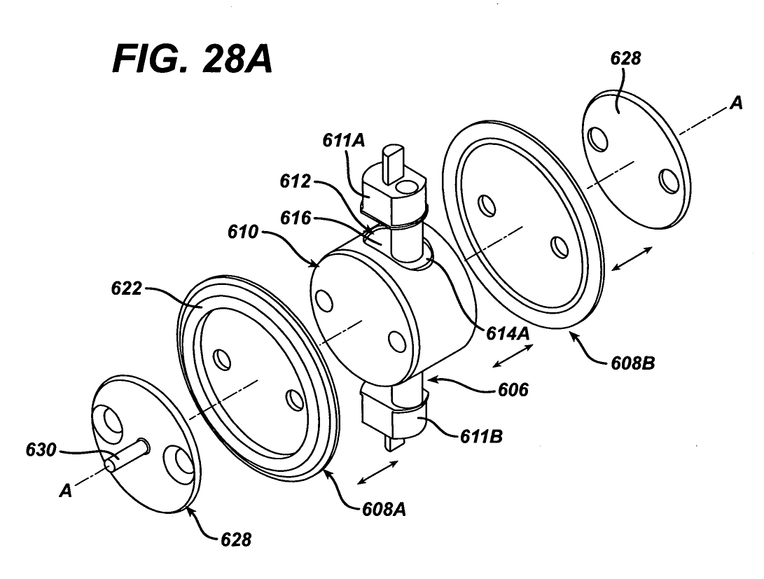

It is generally easier to provide a small, ergonomically shaped oral care device if the compressor has a linear configuration, particularly if the compressor is provided in the handle of the device. By “linear configuration,” we mean that the motor and compressor housing are linearly aligned, and of a similar diameter. This is accomplished with a shuttle that replaces connecting rods used in conventional diaphragm and piston compressors, whose motor and compressor housing are perpendicularly aligned thus being less suitable for ergonomically fitting into a handle. An example of a suitable dual diaphragm air compressor having a linear configuration is shown in FIGS. 27-28A. Compressor 600 includes a compressor assembly 602 and a motor 604, joined to the compressor assembly by a motor mount 601 having a counterweight 605. Compressor assembly 602 includes two halves, each half including a diaphragm and valve head assembly 603, shown in detail in FIG. 28 and discussed below. Each diaphragm and valve head assembly 603 includes its own air intake and outlet, and each provides a flow of compressed air, as will be explained below. Compressor 600 may have, for example, a diameter of less than about 1.25 inch, with an output pressure of at least 15 psi and flow rate of at least 4 liters/min.

Referring to FIGS. 28-28A, a crankshaft 606, which extends from and is driven by motor 604, causes the alternating deflection of two diaphragms 608A, 608B, disposed on opposite sides of the shuttle 610, each diaphragm being part of one of the diaphragm and valve head assemblies. Crankshaft 606 is eccentrically mounted on a pair of shaft mounts 611A, 611B. The lower shaft mount 611A is collinearly mounted on a drive shaft of the motor 604, so that rotation of the drive shaft causes crankshaft 606 to pivot back and forth through an arc. This pivoting movement of the crankshaft is translated into deflection of the diaphragms by a shuttle 610. Shuttle 610 includes a rectangular slot 612, through which the crankshaft extends, with rollers 614A, 614B of the crankshaft (FIG. 28) being dimensioned to contact the inner wall 616 of the slot 612. When the crankshaft pivots, the shuttle 610 translates back and forth along a center axis A of the diaphragms (arrows, FIG. 28A). This motion of the shuttle pushes the diaphragms 608A, 608B in and out of respective compression chambers 618A, 618B, defined by a pair of elastomeric domes 619 (FIG. 27A) that are positioned in housing 620. Deflection of the diaphragms by the shuttle draws air into the compression chambers and then expels air out of the outflow of the compressor. Each of the diaphragm includes a convolute 622, which causes the diaphragms to deflect with a rolling movement, which tends to extend the life of the diaphragms.

For maximum efficiency and diaphragm life, it is desirable that motion of the shuttle be limited, as much as possible, to motion along axis A. Motion in other directions is inhibited by the rectangular shape of slot 612. Motion in other directions is further inhibited by a guide pin 630 that extends from each of a pair of guide disks 628, generally along axis A. Referring to FIG. 27A, each guide pin is mounted for sliding movement in a guide sleeve 632 in housing 620. Thus, non-axial movement of the shuttle and diaphragm is constrained by guide disk 628 which moves linearly along axis A due to the sliding engagement of guide pin 630 in guide sleeve 632. It is generally preferred that the guide pins and guide sleeves be formed of durable, low friction materials, for example stainless steel and/or low friction polymers such as TEFLON, DELRIN, and PEEK polymers.

Because the guide pins inhibit wobbling and other non-axial movement, the headspace clearance between the diaphragm and dome, at the top of the compression stroke, is reduced. Because the diaphragm can get closer to the dome, the headspace that would have otherwise been needed to compensate for diaphragm wobble can instead be used for additional stroke volume, thereby increasing compression.

It is also advantageous, for ease of manufacturing, that the compressor has a “sandwich” or “stacked” configuration, with each side of the compressor being assembled as a stack including the disk, diaphragm and shuttle, and, on the outer side of the disk, the caps that hold the assembly together.

Referring to FIG. 27A, when the compressor is in use, air is drawn into each side of the compressor through an inlet 634. Air is then compressed first in one chamber 618, and then in the other, by the reciprocating motion of the shuttle. Thus, air is expelled first from one air outlet 638 and then from the other, providing a steady stream of compressed air. Inlet 634 and outlet 638 are provided with valves 636 and 640, respectively, (e.g., flapper valves) to control the flow of air into and out of the compressor.

If desired, a similar linear configuration could be used in a single diaphragm compressor,or in compressors having more than two diaphragms, e.g., three or more.

### OTHER EMBODIMENTS

A number of embodiments of the invention have been described. Nevertheless, it will be understood that various modifications may be made without departing from the spirit and scope of the invention.

For example, the oral care system can be designed to eject the air-liquid combination relatively continuously or, alternatively, the air-liquid combination can be delivered in the form of intermittent bursts (e.g., as a pulsating spray). This can be accomplished, for example, by periodically interrupting the compressed air (e.g., using an impeller).

Moreover, other arrangements of the components of the oral care device may be used. For example, in the embodiment shown in FIG. 20 and similar designs, the motor 235 may be a dual shaft motor, in which case the motor 235 may be positioned between the compressor 200 and the coupling 240, rather than between the compressor 200 and the reservoir 220. In this case, the motor can be used to drive both the compressor and the head drive. This alternative arrangement may provide advantages with regard to the plumbing and the ergonomic shape of the device, and may minimize noise.

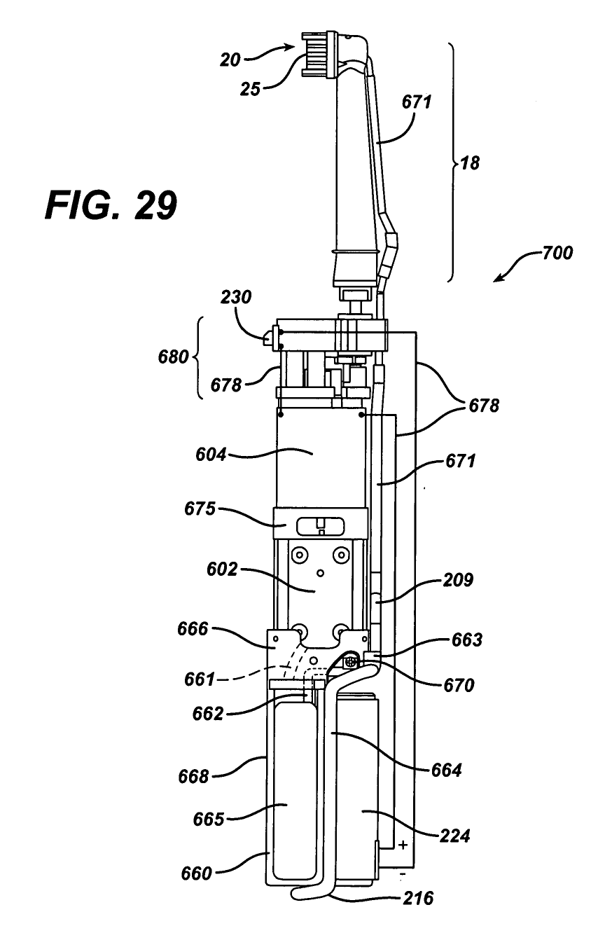

Other types of self-contained oral care devices are within the scope of the claims. For example, the oral care device 700 shown in FIG. 29 includes a linear dual diaphragm compressor, a single motor driving both the compressor and brush head, and a pressurized chamber with a flexible reservoir bag and an adjustable flow restrictor to dispense liquid at a controlled flow rate without using a mechanically driven liquid pump. Referring to FIG. 29, the linear dual diaphragm compressor 602 provides the benefits of reduced size for a given pressure, ˜8-10 psi, and compact geometry resulting in an overall handle volume of less than 200 cc. It is driven by a dual shaft motor 604 that is selected to operate at 7.4 VDC, and provide an RPM that is suitable for both the compressor and brush head performance. This voltage requirement accommodates Li ion battery technology that is currently capable of providing the power needed to operate the device 700 for multiple brushing treatments.

The pressurized chamber 660 is comprised of a rigid housing 668 in which a flexible reservoir bag 665 is placed. The rigid housing 668 is capped with a manifold 666. The manifold 666 has an air inlet 661 which originates from the output port of the air compressor 602. This creates pressure around the flexible reservoir bag 665, which forces liquid out a tube 664 that passes through the manifold 666. An adjustable flow restrictor 670 is placed onto the pressurized chamber's air exit line 663 and adjusted to achieve the desired air-to-liquid ratio. The air exit line 663 and liquid exit line 664 combine at the air/liquid junction 209, to create the air/liquid combination, which travels inside conduit 671 and exits from the nozzle's outlet 25 in the brush head 20. The distal portion 18 is, in this case, a removable brush head assembly with an external air/liquid conduit 671 attached to it. The on-off switch 230 simultaneously turns the compressor, brush head and air/liquid combination on and off. Electrical leads 678 run from the batteries 224 to the switch 230 and motor 604. The motor 604 drives the compressor 602 through coupling 675, and simultaneously drives the brush head through head drive coupling assembly 680.

Advantages to this design include the elimination of a mechanically driven liquid pump, thus conserving space and power, and the ability to dispense liquid in all orientations of the device since the reservoir is pressurized. It also allows for the adjustment of the air-to-liquid ratio, which could be preset in manufacturing or be a consumer adjustable feature. It does not require a pressurized bladder, a one-way check valve or a bleeder valve on the on/off switch, thus simplifying the design and conserving space. The one-way check valve 205 (FIG. 20) is essentially replaced by the adjustable air flow restrictor 670, which since it provides an air vent through the restrictor 670 even when the device is off, also eliminates the need for bleeder valve 234 (FIG. 20). This design offers refilling options by making it relatively easy to design a removable/replaceable cartridge, and by providing a fill port 216 and a chamber 660 and bag 665 that remain in the device 700 to accommodate refilling with a docking station.

The chamber 660 and flexible bag 665 can also be integrated with the batteries 224 to create a reservoir/battery assembly (not shown). This allows battery recharging and liquid refilling to be accomplished in one step, by removing the reservoir/battery assembly from the device 700, and loading the reservoir/battery assembly into a reservoir/battery assembly recharging/refilling docking station (not shown). This arrangement has the added advantage of allowing the batteries' electrical contacts to be kept inside of the device 700, making it unlikely that the contacts will get wet during brushing and thus reducing the likelihood of corrosion of the contacts.

Accordingly, other embodiments are within the scope of the following claims.

What is claimed is:

1. An oral care device capable of ejecting an air-liquid combination, the oral care device comprising:
an applicator including a passageway within the applicator for directing the air-liquid combination therethrough;
a plurality of brushing elements extending from a base at a head of the applicator to free distal ends, the head being sized to fit in a user's mouth; and
a nozzle, in communication with the passageway and extending outwardly from the base at the head, the nozzle having an elastomeric portion and being configured to direct liquid droplets of the air-liquid combination beyond free distal ends of the brushing elements during brushing.

2. The oral care device of claim 1, wherein the nozzle has an inner diameter of between about 0.2 and about 0.8 millimeters.

3. The oral care device of claim 2, wherein the nozzle has an inner diameter of about 0.5 millimeters.

4. The oral care device of claim 1, wherein the nozzle extends outwardly beyond the base to a height (H) of between about 0.1 millimeters and about 10 millimeters.

5. The oral care device of claim 4, wherein the nozzle extends outwardly beyond the base to a height (H) of about 5 millimeters.

6. The oral care device of claim 1, wherein the elastomeric portion comprises a material having a hardness of less than 80 Shore A.

7. The oral care device of claim 1, wherein liquid is ejected from the nozzle at a rate of between about 0.5 and about 6.0 milliliters per minute.

8. The oral care device of claim 7, wherein liquid is ejected from the nozzle at a rate between 2.5 and 4.0 milliliters per minute.

9. The oral care device of claim 1 in the form of a power toothbrush, wherein the head is movable about an axis of rotation.

10. The oral care device of claim 9, wherein the nozzle coextends along the axis of rotation.

11. The oral care device of claim 9, wherein the nozzle is offset from the axis of rotation.

12. The oral care device of claim 1 in the form of a manual toothbrush, wherein the head is stationary.

13. The oral care device of claim 12, wherein the nozzle is positioned at a toe of the oral care device.

14. The oral care device of claim 1 including a movable head portion and a stationary head portion.

15. The oral care device of claim 14, wherein the nozzle is positioned at the stationary head portion.

16. The oral care device of claim 14, wherein the nozzle is positioned at the movable head portion.

17. The oral care device of claim 1 further comprising a second nozzle positioned at the head.

18. The oral care device of claim 17, wherein the second nozzle extends outwardly beyond the base.

19. The oral care device of claim 17, wherein the second nozzle includes an elastomeric portion.

20. The oral care device of claim 1, wherein the nozzle is configured to be relatively imperceptible by the user while brushing.

21. An oral care system for home use by a consumer, the oral care system comprising:
a compressor for generating pressurized air;
a liquid supply configured to allow liquid to be introduced to the pressurized air to form an air-liquid combination;
an applicator including a passageway within the applicator extending to an outlet at a head of the applicator for ejecting the air-liquid combination, the head being sized to fit within the consumer's mouth; and
a plurality of brushing elements extending from a base at the head of the applicator;
wherein the compressor compresses the pressurized air within the passageway to between about five and about 25 pounds per square inch.

22. The oral care system of claim 21, further comprising a pump configured to introduce liquid to the pressurized air at a rate between about 0.5 and 20 milliliters per minute.

23. The oral care system of claim 22, wherein the pump introduces liquid to the pressurized air at a rate between about 0.5 and 6.0 milliliters per minute.

24. The oral care system of claim 23, wherein the pump introduces liquid to the pressurized air at a rate of about 2.5 and 4.0 milliliters per minute.

25. The oral care system of claim 21 further comprising a nozzle positioned at the head of the applicator and configured to eject the liquid droplets of the air-liquid combination beyond free distal ends of the brushing elements.

26. The oral care system of claim 25, wherein the nozzle extends outwardly beyond the base a height (H) of between about 0.1 millimeters and about 10 millimeters.

27. The oral care system of claim 26, wherein the nozzle extends outwardly beyond the base to a height (H) of about 5 millimeters.

28. The oral care system of claim 25, wherein the nozzle has an inner diameter of between about 0.2 and about 0.8 millimeters.

29. The oral care system of claim 28, wherein the nozzle has an inner diameter of about 0.5 millimeters.

30. The oral care system of claim 25, wherein the nozzle comprises an elastomeric material.

31. The oral care system of claim 30, wherein the elastomeric material comprises silicone.

32. The oral care system of claim 21 further comprising a docking station.

33. The oral care system of claim 32, wherein the docking station includes a housing portion, the housing portion containing the compressor and the pump.

34. The oral care system of claim 33, wherein a fluid conduit connects the applicator and the docking station, the fluid conduit providing communication between the docking station and the passageway of the applicator.

35. The oral care system of claim 32, wherein the docking station is configured to supply power and/or liquid to the oral care device, or a portion thereof.

36. The oral care system of claim 33 comprising a first housing passageway connected to the compressor for directing a pressurized air within the housing portion and a second housing passageway connected to a liquid reservoir for directing a liquid within the housing portion, the first and second housing passageways intersecting within the housing portion for combining the liquid and the pressurized air.

37. The oral care system of claim 32 comprising a first liquid reservoir housed by the docking station.

38. The oral care system of claim 37, wherein the first liquid reservoir is removably housed by the docking station.

39. The oral care system of claim 37, wherein the first liquid reservoir defines a relatively cylindrical chamber for holding a liquid.

40. The oral care system of claim 39, wherein the first liquid reservoir includes a plunger configured to adjust its position within the chamber in response to changing fluid level within the chamber.

41. The oral care system of claim 37, wherein the first liquid reservoir includes a one-way valve.

42. The oral care system of claim 37, wherein the first liquid reservoir is in the form of a bag.

43. The oral care system of claim 37, wherein the first liquid reservoir is disposable.

44. The oral care system of claim 37, wherein the first liquid reservoir is refillable.

45. The oral care system of claim 37 further comprising a second liquid reservoir.

46. The oral care system of claim 45, further comprising a pump configured to draw liquid from each of said first and second reservoirs and introduce the liquid to pressurized air.

47. The oral care system of claim 46 comprising first and second fluid passageways for directing liquid, respectively, from said first and second reservoirs.

48. The oral care system of claim 47, wherein said first liquid reservoir contains a first liquid and said second reservoir contains a second liquid different from the first liquid.

49. The oral care system of claim 48, wherein the first and second fluid passageways intersect within the housing for combining the liquids.

50. The oral care system of claim 49, wherein the first and second fluids are isolated from each other as they travel along respective fluid passageways.

51. The oral care system of claim 21 comprising an obstructing member configured to periodically impede movement of pressurized air traveling from the compressor to decrease a flow rate of liquid ejected from the outlet.

52. The oral care system of claim 30 wherein the elastomeric material has a hardness of less than 80 Shore A.

53. An oral care device capable of ejecting an air-liquid combination, the oral care device comprising:
an applicator including a passageway within the applicator for directing the air-liquid combination therethrough;
a plurality of brushing elements extending from a base at a head of the applicator, the head being sized to fit within a user's mouth; and
multiple nozzles extending from the base, at least one of the nozzles being in communication with the passageway for ejecting the air-liquid combination.

54. An oral care system capable of ejecting an air-liquid combination, the oral care system comprising:
an applicator including a passageway within the applicator for directing a pressurized air therethrough; and
an obstructing member configured to interrupt the pressurized air within the passageway such that the air-liquid combination is ejected from the applicator as pulses.

55. The oral care system of claim 54, wherein the obstructing member is an impeller.

56. An oral care device capable of ejecting an air-liquid combination, the oral care device comprising:
an applicator including multiple passageways within the applicator, each of the multiple passageways arranged to direct a respective air-liquid combination to at least one outlet at a head of the applicator.

57. The oral care device of claim 56 comprising first and second air-liquid combinations, wherein the first air-liquid combination comprises a first liquid, and the second air-liquid combination comprises a second liquid.

58. The oral care device of claim 57, wherein the first and second liquids have different formulations.

59. The oral care device of claim 58, wherein the first and second liquids contain different actives.

60. The oral care device of claim 58, wherein the first and second liquids have different rheologies.

61. A method of oral care, the method comprising:
projecting liquid in the form of liquid droplets outwardly beyond free distal ends of brushing elements extending from a base at a head of an oral care device; while brushing with the brushing elements.

62. The method of claim 61, wherein the step of projecting the air-liquid combination occurs while at least some of the brushing elements contact the user's teeth.

63. The method of claim 61, wherein the liquid is projected at a rate of between about 0.5 and about 6.0 milliliters per minute.

64. The method of claim 63, wherein the liquid is projected at a rate of about 2.5 and about 4.0 milliliters per minute.

65. The method of claim 61, wherein the liquid droplets are projected in an air-liquid combination.

66. The method of claim 65 further comprising pressurizing air using a compressor.

67. The method of claim 66, wherein the air is pressurized to between about five and about 25 pounds per square inch.

68. The method of claim 67 comprising drawing liquid from a liquid reservoir using the compressor.

69. The method of claim 68, wherein the compressor is a diaphragm compressor.

68. The method of claim 66 further comprising introducing liquid to the pressurized air using a pump.

69. The method of claim 68, wherein the pump introduces liquid to the pressurized air at a rate between about 0.5 and 20 milliliters per minute.

70. The method of claim 69, wherein the pump introduces liquid to the pressurized air at a rate between about 0.5 and 6.0 milliliters per minute.

71. The method of claim 70, wherein the pump introduces liquid to the pressurized air at a rate of about 2.5 and 4.0 milliliters per minute.

72. The method of claim 61, wherein projecting liquid in the form of liquid droplets outwardly beyond free distal ends of brushing elements includes ejecting the liquid from a nozzle positioned at the base.

73. The method of claim 72, wherein the nozzle comprises a flexible material.

74. The method of claim 73, wherein the material comprises silicone.

75. The method of claim 72, wherein the nozzle extends outwardly beyond the base a height (H) of between about 0.1 millimeters and about 10 millimeters.

76. The method of claim 75, wherein the nozzle extends outwardly beyond the base to a height (H) of about 5 millimeters.

77. An oral care device capable of ejecting an air-liquid combination, the oral care device comprising:
an applicator including a passageway within the applicator for directing the air-liquid combination therethrough, the applicator having a head portion sized to fit in a user's mouth;
within the applicator, a compressor for providing compressed air to the drive the air-liquid combination; and
a nozzle having an elastomeric portion, in communication with the passageway and extending outwardly beyond the base at the head, the nozzle being configured to direct liquid droplets of the air-liquid combination beyond free distal ends of the brushing elements during brushing.

78. The oral care device of claim 77 further comprising a plurality of brushing elements extending from a base at the head portion of the applicator to free distal ends.

79. The oral care device of claim 77 further comprising, within the applicator, a power source configured to drive the compressor.

80. The oral care device of claim 79 wherein the head is movable and the power source is configured to also drive the head.

81. The oral care device of claim 77 further comprising, within the applicator, a reservoir configured to contain a supply of liquid for delivery to the air-liquid combination.

82. The oral care device of claim 81 wherein the oral care device is configured so that liquid is delivered to the compressor for mixing with the air.

83. The oral care device of claim 81 wherein the oral care device is configured so that liquid is delivered to the air downstream of the compressor.

84. The oral care device of claim 81 wherein the applicator includes an inlet configured to allow the reservoir to be refilled.

85. The oral care device of claim 84 wherein the inlet is configured to engage a corresponding outlet on a docking station.

86. The oral care device of claim 81 wherein the reservoir is replaceable by a user of the oral care device.

87. The oral care device of claim 81 wherein the oral device is configured so that the contents of the reservoir can be delivered regardless of the orientation of the oral care device.

88. The oral care device of claim 87 wherein the liquid reservoir is flexible, and is connected to an input of the compressor so that suction collapses the reservoir as liquid is drawn into the compressor along with air.

89. The oral care device of claim 87 wherein the liquid reservoir is flexible, and is surrounded by a pressurized air reservoir which applies pressure to the flexible liquid reservoir and forces the liquid out downstream of an outlet of the compressor.

90. The oral care device of claim 81 wherein the power requirements of the device do not exceed 15 W.

91. The oral care device of claim 77 wherein the oral care device has a total volume of less than about 200 cc.

92. The oral care device of claim 1 wherein the power requirements of the device do not exceed 20 W.

93. The oral care device of claim 92 wherein the power requirements of the device do not exceed 15 W.

94. The oral care device of claim 1 wherein the nozzle is flexible.

95. The oral care device of claim 34 wherein the length of the fluid conduit is from about 100 to 175 cm.

96. The oral care device of claim 22 wherein the pump is configured to produce an output pressure that is greater than the pressure of the pressurized gas in the passageway, to insure liquid flow into the passageway.

97. The oral care device of claim 32 wherein the docking station has a footprint area of less than about 200 cm².

98. The oral care device of claim 1 wherein the oral care device has a volume of less than about 200 cc.

99. The oral care device of claim 32 wherein the total volume of the docking station and oral care device is less than about 3200 cc.

100. The oral care device of claim 21 further comprising a relief valve, vented to the atmosphere, disposed within the passageway between the compressor and a point at which the liquid is introduced.

101. The oral care device of claim 100, further comprising a one-way check valve positioned between the relief valve and the point at which liquid is introduced.

102. The oral care device of claim 1 wherein oral care device is configured so that the height to which the nozzle extends outwardly from the base is adjustable by the user.

103. The oral care device of claim 102 wherein the nozzle is fixed and the brush head is configured to move along a spiral incline when the head is twisted by the user.

104. The oral care device of claim 103 wherein the spiral incline includes indents that lock the head in a plurality of different height positions relative to the nozzle.

105. The oral care device of claim 1, further comprising circuitry configured to prevent a user from receiving an electrical shock if the oral care device is immersed in water.

106. The oral care device of claim 6 wherein the elastomeric portion has a hardness of less than 80 Shore A.

107. The oral care device of claim 1 or 6 wherein the elastomeric portion comprises a silicone elastomer.

108. The oral care device of claim 1 wherein the entire nozzle is formed of an elastomeric material.
